(19) United States
(12) Patent Application Publication
(10) Pub. No.: US 2020/0012041 A1
(43) Pub. Date: Jan. 9, 2020

(54) POLARIZATION MAINTAINING FIBER, OPTICAL DEVICE, PREFORM OF POLARIZATION MAINTAINING FIBER, AND MANUFACTURING METHOD

(71) Applicant: FUJIKURA LTD., Tokyo (JP)

(72) Inventors: Kentaro Ichii, Chiba (JP); Keisuke Hirakawa, Chiba (JP); Kazuyuki Hayashi, Chiba (JP)

(73) Assignee: FUJIKURA LTD., Tokyo (JP)

(21) Appl. No.: 16/495,870

(22) PCT Filed: Mar. 22, 2018
(86) PCT No.: PCT/JP2018/011543

§ 371 Date: Sep. 20, 2019

(30) Foreign Application Priority Data
Mar. 22, 2017 (JP) 2017-056175
Mar. 22, 2018 (JP) 2018-055353

(51) Int. Cl. G02B 6/024; G02B 6/036; G02B 6/255

(52) U.S. Cl. CPC G02B 6/024; G02B 6/2551; G02B 6/036

(57) ABSTRACT

A polarization maintaining fiber includes: a core; an inner cladding enclosing the core; two stress applying parts that sandwich the inner cladding therebetween; and an outer cladding enclosing the inner cladding and the two stress applying parts. Each of the two stress applying parts is depressed inward against the inner cladding, and the core has a flattened cross section having a long-axis that corresponds to a direction in which the two stress applying parts are aligned.

### TECHNICAL FIELD

The present invention relates to a polarization maintaining fiber having a flattened core. The present invention also relates to an optical device including the polarization maintaining, a preform of the polarization maintaining fiber, and a method for manufacturing the polarization maintaining fiber.

### BACKGROUND

In the field of silicon photonics, polarization maintaining fibers are widely used as transmission media for transmission of light inputted to a silicon waveguide or light outputted from a silicon waveguide. The term “polarization maintaining fiber” refers to an optical fiber having a polarization maintaining performance which is enhanced by suppression of coupling between different polarization modes. A typical example of the polarization maintaining fiber is a polarization-maintaining and absorption-reducing (PANDA) fiber in which stress applying parts for applying stress to a core is provided in a cladding.

In a polarization maintaining fiber including two stress applying parts, a cross section of the core may have a flattened shape (i.e., the shape of the cross section be not a true circle shape or square shape but an elliptical shape or rectangular shape) depending on intended use. This is for the following reasons. First, when the cross section of the core has a flattened shape, the polarization maintaining performance can be enhanced. Second, when the cross section of the core has a flattened shape, it is possible to make a mode field of the polarization maintaining fiber elliptical. A mode field of a silicon waveguide is typically elliptical. Therefore, as compared to a polarization maintaining fiber whose mode field has a true circle shape, a polarization maintaining fiber whose mode field is elliptical is capable of reducing a coupling loss to a lower level at a connection between the polarization maintaining fiber and the silicon waveguide.

Note that the polarization maintaining performance can be enhanced by flattening the cross section of the core, in a case where a long-axis (longitudinal direction or long-side direction) of the cross section of the core becomes parallel to a direction in which two stress applying parts are aligned and accordingly, birefringence caused by the two stress applying parts and birefringence caused by flattening of the core mutually increase each other. In a case where the long-axis of the cross section of the core is perpendicular to the direction in which the two stress applying parts are aligned, the birefringence caused by the two stress applying parts and the birefringence caused by flattening of the core mutually decrease each other. Accordingly, no polarization maintaining performance enhancing effect can be achieved.

One known example of a method for manufacturing an optical fiber whose core has a flattened cross section is a manufacturing method disclosed in Patent Literature 1. According to Patent Literature 1, it is possible to manufacture, by carrying out the following steps, an optical fiber whose core has an elliptical cross section. Step 1: Prepare a first preform by forming a primary cladding part on an entire outer periphery of a core part having a cross section in the shape of a true circle. Step 2: Prepare a second preform by cutting, along a long-axis of the first preform, lateral-side outer portions of the primary cladding part of the first preform (hereinafter, such “cutting” of an outer portion(s) along a long-axis of a preform is referred to as “outer cutting”). Step 3: Prepare a third preform by forming a soot of a secondary cladding part on an entire outer periphery of the primary cladding part of the second preform. Step 4: Form a fourth preform, by sintering the third preform (soot rod) by heating the third preform in a dehydrated atmosphere. During formation of the fourth preform, volume shrinkage occurs due to disappearance of pore portions, so that the shape of the cross section of the core part changes from the shape of a true circle to an elliptical shape. Step 5: Prepare a fifth preform, by outer cutting of the fourth preform so that the fifth preform will have a cross section in the shape of a true circle. Step 6: Obtain an optical fiber whose core has an elliptical cross section, by drawing the fifth preform.
[Patent Literature 1] Japanese Patent Application Publication, Tokukai, No. 2002-365463 (Published on Dec. 18, 2002)

The manufacturing method disclosed in Patent Literature 1 has the following features.

That is, in the manufacturing method disclosed in Patent Literature 1, it is necessary to perform outer cutting two times before a preform is completed. Particularly, in order to make the elliptical cross section of the core have a sufficient non-circularity, outer cutting of the first preform needs to be performed until a length of a cut portion of the first preform along a radius of the first preform becomes approximately half a length of a remaining portion of the first preform along the radius of the first preform, which remaining portion has not been cut (see FIG. 2 and paragraph [0024] of Patent Literature 1). Thus, a long time is required for the outer cutting and the optical fiber cannot be easily manufactured.

### SUMMARY

One or more embodiments of the present invention provide a polarization maintaining fiber having two stress applying parts and a core whose cross section is flattened, which polarization maintaining fiber can be easily manufactured. One or more embodiments of the present invention also provide an optical device including the polarization maintaining fiber, a preform of the polarization maintaining fiber, or a method for manufacturing the polarization maintaining fiber.

A polarization maintaining fiber in accordance with an aspect of the present invention may be configured to include: a core; an inner cladding enclosing the core; two stress applying parts provided on both sides of the inner cladding and sandwiching the inner cladding therebetween; and an outer cladding enclosing the inner cladding and the two stress applying parts, the inner cladding causing each of the two stress applying parts to be depressed inward upon the inner cladding such that the inner cladding is received in a depression of each of the two stress applying parts, and the core having a cross section flattened such that a long-axis of the core corresponds to a direction in which the two stress applying parts are aligned.

A polarization maintaining fiber preform in accordance with an aspect of the present invention may be configured to include: a core; an inner cladding enclosing the core; two stress applying parts provided on both sides of the inner cladding and sandwiching the inner cladding therebetween; and an outer cladding enclosing the inner cladding and the two stress applying parts, each of the two stress applying parts causing the inner cladding to be depressed inward upon each of the two stress applying parts such that each of the two stress applying parts is received in a depression of the inner cladding.

A method, in accordance with an aspect of the present invention, for manufacturing a polarization maintaining fiber may be configured to include the step of: drawing a preform including a core, an inner cladding enclosing the core, stress applying parts provided on both sides of the inner cladding and sandwiching the inner cladding therebetween, and an outer cladding enclosing the inner cladding and the two stress applying parts, in the preform, each of the two stress applying parts causing the inner cladding to be depressed inward upon each of the two stress applying parts such that each of the two stress applying parts is received in a depression of the inner cladding, and in the polarization maintaining fiber, the inner cladding causing each of the two stress applying parts to be depressed inward upon the inner cladding such that the inner cladding is received in a depression of each of the two stress applying parts, and the core having a cross section flattened such that a long-axis of the core corresponds to a direction in which the two stress applying parts are aligned.

One or more embodiments of the present invention make it possible to provide a polarization maintaining fiber including a core whose cross section is flattened, which polarization maintaining fiber can be easily manufactured. Further, one or more embodiments of the present invention make it possible to provide an optical device including the polarization maintaining fiber, a preform of the polarization maintaining fiber, or a method for manufacturing the polarization maintaining fiber.

### BRIEF DESCRIPTION OF DRAWINGS

FIG. 1 is a diagram illustrating a structure of a polarization maintaining fiber in accordance with one or more embodiments of the present invention. FIG. 1A is a cross sectional view illustrating a transverse cross section of the polarization maintaining fiber. FIG. 1B is a graph showing a refractive index distribution along a straight line AA′ of the cross section illustrated in FIG. 1A. FIG. 1C is a graph showing a refractive index distribution along a straight line BB′ of the cross section illustrated in FIG. 1A.

FIG. 2 is a diagram illustrating a method for manufacturing the polarization maintaining fiber illustrated in FIG. 1.

FIG. 3 is a photograph showing a cross section of the polarization maintaining fiber which has been manufactured by the method illustrated in FIG. 2.

FIG. 4A is a diagram illustrating definitions of specifications of preforms in accordance with Comparative Examples. FIG. 4B is a diagram illustrating definitions of specifications of polarization maintaining fibers in accordance with Comparative Examples.

FIG. 5A is a diagram illustrating definitions of specifications of preforms in accordance with Examples. FIG. 5B is a diagram illustrating definitions of specifications of polarization maintaining fibers in accordance with Examples.

FIG. 6 is a side view of an optical device to which the polarization maintaining fiber illustrated in FIG. 1 is applicable.

FIG. 7A is an elevational view illustrating a substrate-type optical waveguide provided in the optical device illustrated in FIG. 6. FIG. 7B is an elevational view illustrating a first optical fiber provided in the optical device illustrated in FIG. 5.

FIG. 8A is a graph showing a mode field pattern of the substrate-type optical waveguide provided in the optical device illustrated in FIG. 6. FIG. 8B is a graph showing a mode field pattern of the first optical fiber provided in the optical device illustrated in FIG. 6.

FIG. 9 is a side view of a polarization maintaining fiber during drawing.

### DETAILED DESCRIPTION

(Structure of Polarization Maintaining Fiber)

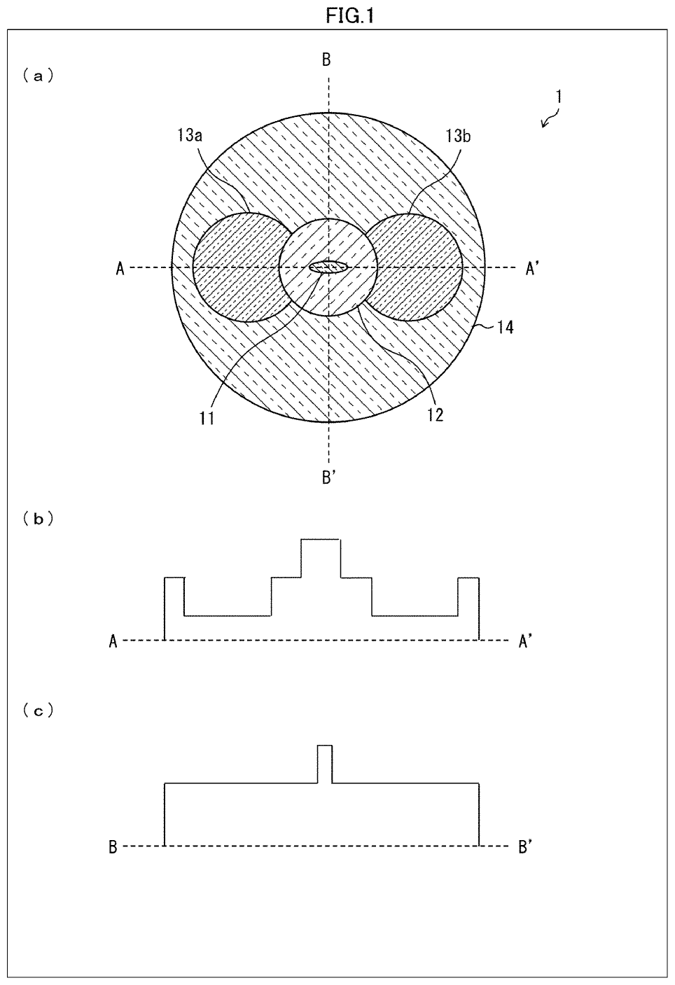

The following will discuss a structure of a polarization maintaining fiber 1 in accordance with one or more embodiments of the present invention, with reference to FIG. 1. FIG. 1A is a cross sectional view illustrating a transverse cross section of the polarization maintaining fiber 1. FIG. 1B is a graph showing a refractive index distribution of the polarization maintaining fiber 1 along a straight line AA′ of the cross section illustrated in (a) of FIG. 1. FIG. 1C is a graph showing a refractive index distribution of the polarization maintaining fiber 1 along a straight line BB′ of the cross section illustrated in FIG. 1A.

The polarization maintaining fiber 1 includes a core 11, an inner cladding 12 which encloses the core 11, stress applying parts 13a and 13b which are provided on both sides of the inner cladding 12 and sandwich the inner cladding 12 therebetween, and an outer cladding 14 which encloses the inner cladding 12 and the two stress applying parts 13a and 13b, as illustrated in FIG. 1A.

The inner cladding 12 causes each of the two stress applying parts 13a and 13b to be depressed inward upon the inner cladding 12 such that inner cladding 12 is received in a depression of each of the two stress applying parts 13a and 13b. Accordingly, whereas the cross section of the inner cladding 12 has a circular shape, the cross section of the stress applying part 13a on the left side of the inner cladding 12 has a circular shape whose right end portion is missing and the cross section of the stress applying part 13b on the right side of the inner cladding 12 has a circular shape whose left end portion is missing. Further, the cross section of the core 11 has a shape flattened such that a direction in which the two stress applying parts 13a and 13b are aligned corresponds to a long-axis of the core 11 (in one or more embodiments, flattened circular shape, that is, elliptical shape). The direction in which the two stress applying parts 13a and 13b are aligned refers to a direction parallel to a straight line passing the center of the first stress applying part 13a and the center of the second stress applying part 13b.

The core 11 is made of quartz glass which is doped with germanium (Ge). The germanium added to the core 11 has a refractive index increasing effect on the quartz glass. This makes a refractive index n1 of the core 11 higher than the refractive index n0 (approximately 1.46) of pure quartz glass. Meanwhile, the value of a melt viscosity η1 of the core 11 is substantially equal to or slightly lower than the value of the melt viscosity η0 of pure quartz glass.

Note that though in the configuration of one or more embodiments described herein, germanium is added, as an updopant, to the core 11, the present invention is not limited to such a configuration. In other words, it is possible to dope the core 11 with one or both of phosphorus and aluminum as an updopant(s) in addition to germanium. It is alternatively possible to dope the core 11 with germanium oxide, chlorine and/or the like as an updopant(s). Regardless of which updopant is used, it is possible to configure, by appropriately adjusting a concentration of that updopant, a relative refractive index difference of the refractive index n1 of the core 11 to a refractive index n4 of the outer cladding 14 described later (which refractive index n4 is substantially equal to the refractive index of pure quartz glass) such that the relative refractive index difference is not less than 1.0%. Note that in a case where the core 11 is doped with germanium, a concentration of the germanium in the core 11 can be configured to be, for example, 10 wt % to 30 wt %.

The inner cladding 12 is made of quartz glass which is codoped with phosphorus (P) and fluorine (F). The phosphorus added to the inner cladding 12 has a refractive index increasing effect on the quartz glass and also a melt viscosity decreasing effect on the quartz glass. Meanwhile, the fluorine added to the inner cladding 12 has a diffusion promoting effect which promotes diffusion of the germanium added to the core 11 into the inner cladding 12 during heating for fusion-splicing and also a refractive index decreasing effect on the quartz glass. Respective concentrations of the phosphorus and the fluorine added to the inner cladding 12 are adjusted so that the above-described refractive index increasing effect of the phosphorus and the above-described refractive index decreasing effect of the fluorine will cancel each other. This causes a refractive index n2 of the inner cladding 12 to be substantially equal to the refractive index of pure quartz glass. Meanwhile, a melt viscosity η2 of the inner cladding 12 becomes lower than the melt viscosity η0 of pure quartz glass.

Note that though one or more embodiments described herein employ a configuration in which the inner cladding 12 is doped with phosphorus as an updopant, the present invention is not limited to such a configuration. In other words, it is possible to dope the inner cladding 12 with germanium (Ge) as an updopant instead of phosphorus, or alternatively, to dope the inner cladding 12 with germanium as an updopant in addition to phosphorus. Even in a case where the concentration of the fluorine in the inner cladding 12 is high, it is possible to configure, by doping the inner cladding 12 with both of phosphorus and germanium, a relative refractive index difference of the refractive index n2 of the inner cladding 12 to the refractive index n4 of the outer cladding 14 (substantially equal to the refractive index of pure quartz glass) such that the relative refractive index difference is not more than 0.1%. Note that in a case where the inner cladding 12 is doped with phosphorus, germanium, and fluorine, the concentration of the phosphorus in the inner cladding 12 can be, for example, 0.5 wt % to 2.0 wt % and the concentration of the germanium in the inner cladding 12 can be, for example, 1.5 wt % to 5.0 wt %. The concentration of the fluorine in the inner cladding 12 should be set so that the relative refractive index difference of the refractive index n2 of the inner cladding 12 to the refractive index n4 of the outer cladding 14 will be not more than 0.1%.

The two stress applying parts 13a and 13b are each made of quartz glass which is doped with boron (B). The boron added to the stress applying parts 13a and 13b has a refractive index decreasing effect on the quartz glass and also a melt viscosity decreasing effect on the quartz glass. This causes a refractive index n3 of the stress applying parts 13a and 13b to be lower than the refractive index n0 of pure quartz glass. Meanwhile, a melt viscosity η3 of the stress applying parts 13a and 13b becomes lower than the melt viscosity 110 of pure quartz glass. Note that it is possible to employ a configuration in which the two stress applying parts 13a and 13b are doped with boron oxide (B₂O₃) instead of the above configuration in which the two stress applying parts 13a and 13b are doped with boron (B). In this case, a concentration of the boron oxide in the two stress applying parts 13a and 13b should be set, for example, in a range of 15 mol % to 25 mol %.

The outer cladding 14 is made of quartz glass which is not intentionally doped with any dopant except for chlorine (Cl). In other words, the quartz glass constituting the outer cladding 14 is doped with neither an updopant, except for chlorine, having a refractive index increasing effect nor a downdopant having a refractive index decreasing effect. A concentration of the chlorine in the outer cladding 14 should be set so that the relative refractive index difference of the refractive index n2 of the inner cladding 12 to the refractive index n4 of the outer cladding 14 will be not more than 0.1%. This causes the refractive index n4 of the outer cladding 14 to be substantially equal to the refractive index n0 of pure quartz glass. Meanwhile, a melt viscosity η4 of the outer cladding 14 is substantially equal to the melt viscosity η0 of pure quartz glass.

As described above, the refractive index n1 of the core 11, the refractive index n2 of the inner cladding 12, the refractive index n3 of the stress applying parts 13a and 13b, and the refractive index n4 of the outer cladding 14 have the following relation: n3<n2≈n4<n1. This relation (in particular, n2<n1) allows the polarization maintaining fiber 1 to have a light confining function.

Further, the melt viscosity η1 of the core 11, the melt viscosity η2 of the inner cladding 12, the melt viscosity η3 of the stress applying parts 13a and 13b, and the melt viscosity η4 of the outer cladding 14 have the following relation: η3<<η2<<η1<η4. Here, the relation η3<<η2 is established because the boron added to the stress applying parts 13a and 13b has a stronger viscosity decreasing effect than the phosphorus added to the inner cladding 12. This relation (in particular, η3<<η2<<η1) allows the polarization maintaining fiber 1 to have a polarization maintaining ability (for the reason why the relation allows the polarization maintaining fiber to have the polarization maintaining ability, see “Method for manufacturing polarization maintaining fiber”). Here, respective dopant concentrations in the core 11, the inner cladding 12, the stress applying parts 13a and 13b, and the outer cladding 14 should be set so that the relation η3<<η2<<η1<η4 will be satisfied. For example, in a case where (i) the core 11 is doped with germanium, (ii) the inner cladding 12 is doped with phosphorus, germanium, and fluorine, (iii) the two stress applying parts 13a and 13b are doped with boron oxide (B₂O₃), and (iv) the outer cladding 14 is made of quartz glass which is not intentionally doped with any dopant except for chlorine (Cl), the respective dopant concentrations as below should be set so that the relation η3<<η2<<η1<η4 will be satisfied. In other words, (i) the concentration of the germanium in the core 11 is set, for example, in a range of 10 wt % to 30 wt %; (ii) the concentration of the phosphorus in the inner cladding 12 is set, for example, in a range of 0.5 wt % to 2.0 wt %, the concentration of the germanium in the inner cladding 12 is set, for example, in a range of 1.5 wt % to 5.0 wt %, and the concentration of the boron oxide in the inner cladding 12 is set so that the relative refractive index difference of the refractive index n2 of the inner cladding 12 to the refractive index n4 of the outer cladding 14 will be not more than 0.1%; (iii) the concentration of the boron oxide in the two stress applying parts 13a and 13b is set, for example, in a range of 15 mol % to 25 mol %; and (iv) the concentration of the chlorine in the outer cladding 14 is set so that the relative refractive index difference of the refractive index n2 of the inner cladding 12 to the refractive index n4 of the outer cladding 14 will be not more than 0.1%, and further, (v) these concentrations should be set so that the relation η3<<η2<<η1<η4 will be satisfied.

(Method for Manufacturing Polarization Maintaining Fiber)

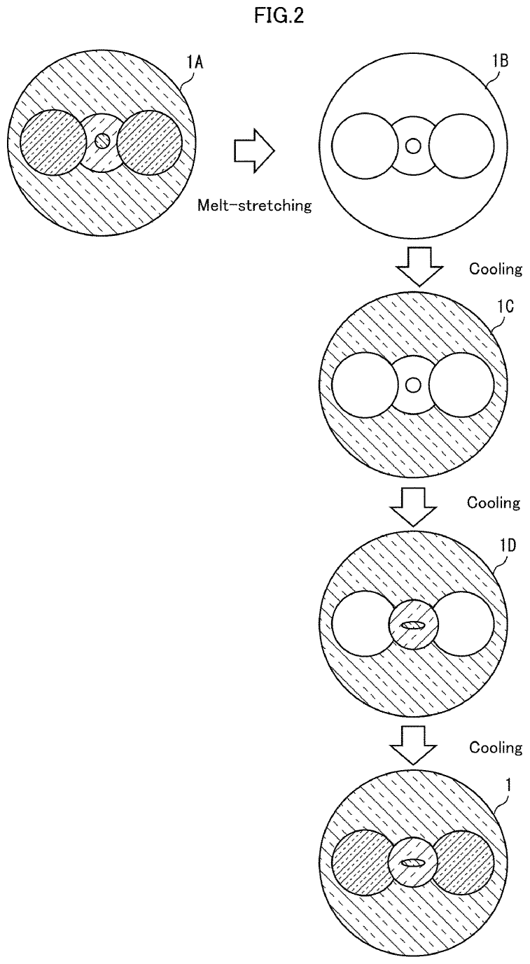

Next, the following will discuss a method for manufacturing the polarization maintaining fiber 1 illustrated in FIG. 1, with reference to FIG. 2. FIG. 2 is a diagram illustrating the method for manufacturing the polarization maintaining fiber 1.

First, a preform 1A is prepared. The preform 1A can be produced, by first forming two holes in, for example, a preform including the core 11, the inner cladding 12, and the outer cladding 14, by using a drilling tool or the like, and then, inserting, into each of these holes, a rod which is a preform of each of the stress applying parts 13a and 13b. The preform 1A has a cross-sectional structure similar to that of the polarization maintaining fiber 1. Note however that in the preform 1A, each of the stress applying parts 13a and 13b (or the holes into which the stress applying parts 13a and 13b are inserted, respectively) causes the inner cladding 12 to be depressed inward upon each of the stress applying parts 13a and 13b such that each of the stress applying parts 13a and 13b is received in a depression of the inner cladding 12 (the inner cladding 12 is depressed and the stress applying parts 13a and 13b are protruding), whereas in the polarization maintaining fiber 1, the inner cladding 12 causes each of the stress applying parts 13a and 13b to be depressed inward upon the inner cladding 12 such that the inner cladding 12 is received in a depression of each of the stress applying parts 13a and 13b (the inner cladding 12 is protruding and the stress applying parts 13a and 13b are depressed). Further, in the preform 1A, the cross section of the core 11 has a circular shape, whereas in the polarization maintaining fiber 1, the cross section of the core 11 has an elliptical shape (flattened circular shape).

Next, the preform 1A is subjected to melt-stretching, so that a polarization maintaining fiber 1B is obtained. In the polarization maintaining fiber 1B, all of the core 11, the inner cladding 12, the stress applying parts 13a and 13b, and the outer cladding 14 are in a melted state.

Then, the polarization maintaining fiber 1B is cooled, so that the polarization maintaining fiber 1C is obtained. In the polarization maintaining fiber 1C, while the outer cladding 14 is in a solidified state, the core 11, the inner cladding 12, and the stress applying parts 13a and 13b are in a melted state. The outer cladding 14 is solidified earlier than the core 11, the inner cladding 12, and the stress applying parts 13a and 13b as described above, because the viscosity η4 of the outer cladding 14 is higher than the viscosity η1 of the core 11, the viscosity η2 of the inner cladding 12, and the viscosity η3 of the stress applying parts 13a and 13b.

Subsequently, the polarization maintaining fiber 1C is cooled, so that a polarization maintaining fiber 1D is obtained. In the polarization maintaining fiber 1D, while the core 11, the inner cladding 12, and the outer cladding 14 are in a solidified state, the stress applying parts 13a and 13b are in a melted state. The core 11, the inner cladding 12, and the outer cladding 14 are solidified earlier than the stress applying parts 13a and 13b as described above, because the viscosity η1 of the core 11, the viscosity η2 of the inner cladding 12, and the viscosity η4 of the outer cladding 14 are higher than the viscosity η3 of the stress applying parts 13a and 13b.

When the core 11 and the inner cladding 12 are solidified, the stress applying parts 13a and 13b are in a melted state. Accordingly, the inner cladding 12 deforms due to surface tension so as to have a circular cross section. When the inner cladding 12 deforms, the core 11 deforms, due to stress caused by the inner cladding 12, so as to have an elliptical cross section.

At the end, the polarization maintaining fiber 1D is cooled, so that the polarization maintaining fiber 1 is obtained. In the polarization maintaining fiber 1, all of the core 11, the inner cladding 12, the stress applying parts 13a and 13b, and the outer cladding 14 are in a solidified state. In the polarization maintaining fiber 1, stress is applied to the core 11 and the inner cladding 12 which are solidified earlier, by the stress applying parts 13a and 13b which are solidified later. This stress allows the polarization maintaining fiber 1 to develop a polarization maintaining function. The above-described polarization maintaining fiber 1B here can also be referred to as a melted preform 1A, and the above-described polarization maintaining fibers 1C and 1D can also be referred to as a preform 1A which has been melted and then cooled.

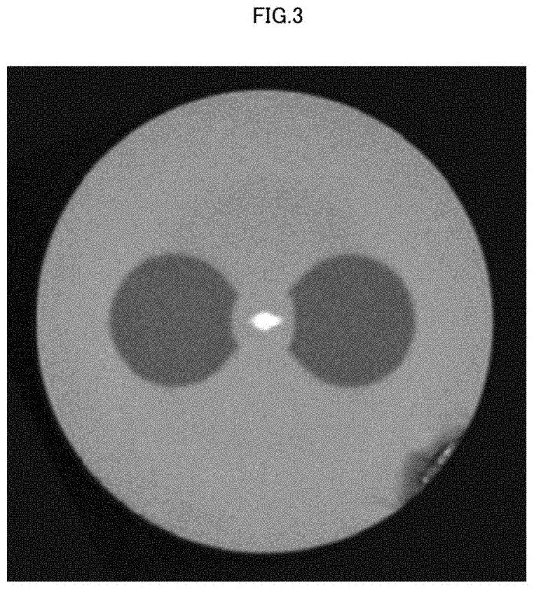

FIG. 3 is a photograph showing a cross section of the polarization maintaining fiber 1 which has been manufactured in accordance with the above manufacturing method. It can be confirmed from this photograph of the cross section that the cross section of the core 11 has an elliptical shape.

Note that the manufacturing method described here is a method in which the cross section of the core 11 in the polarization maintaining fiber 1 is configured to have an elliptical shape (flattened circular shape), by arranging the shape of the cross section of the core 11 in the preform 1A in a circular shape, but the present invention is not limited to such a configuration. For example, the cross section of the core in the polarization maintaining fiber 1 can be configured to have a rectangular shape (flattened square shape), by arranging the shape of the cross section of the core 11 in the preform 1A in a square shape. In general, the cross section of the core 11 in the polarization maintaining fiber 1 manufactured in accordance with the above manufacturing method has a flattened shape of the cross section of the core 11 in the preform 1A.

### EXAMPLES AND COMPARATIVE EXAMPLES

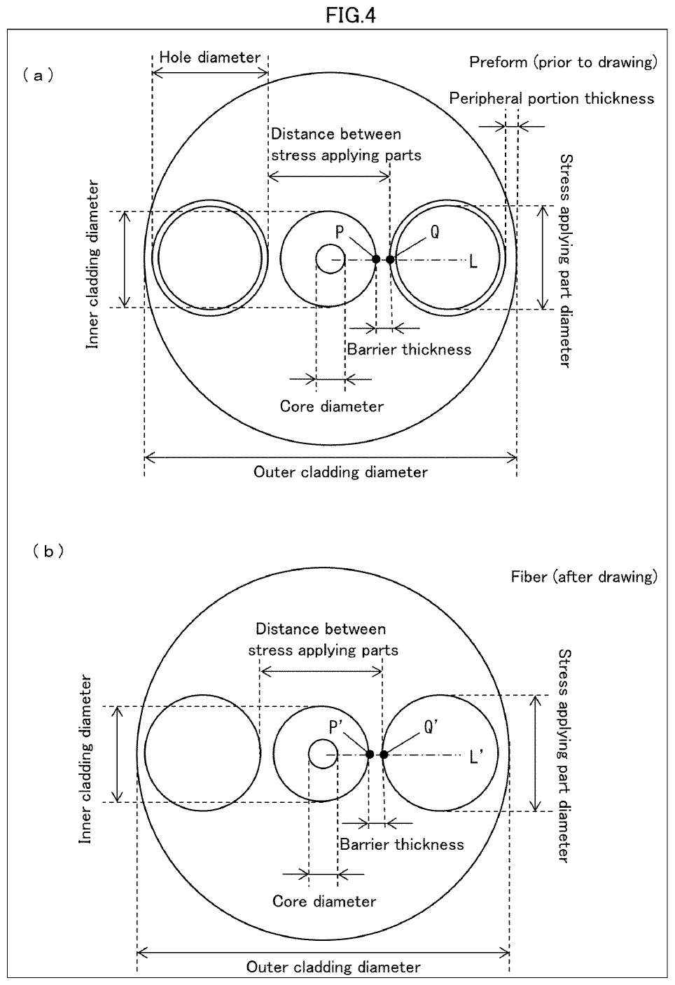

Preforms were prepared. The preforms each had a core diameter, an inner cladding diameter, an outer cladding diameter, a distance between stress applying parts, a barrier thickness, a hole diameter, a stress applying part diameter, and a peripheral portion thickness, which were set as in Table 1 below. A preform having a negative barrier thickness is a preform in which each of two stress applying parts causes an inner cladding to be depressed inward upon each of the two stress applying parts such that each of the two stress applying parts is received in a depression of the inner cladding. In Examples, such preforms are used. In contrast, a preform having a positive barrier thickness is a preform in which each of two stress applying parts is spaced apart from an inner cladding. In Comparative Examples, such preforms are used. Note that specifications of preforms in accordance with Comparative Examples 1 to 3 are defined in FIG. 4A. Meanwhile, specifications of preforms in accordance with Examples 1 to 3 are defined in FIG. 5A. Note that as illustrated in (a) of FIG. 4, in each of the preforms in accordance with Comparative Examples 1 to 3, a half line extending from a center of the preform in parallel to a direction in which the stress applying parts are aligned is represented as “L”, and an absolute value of the barrier thickness is a distance from an intersection P of the half line L and a circle constituting an outer edge of the inner cladding to an intersection Q of the half line L and a circle constituting an outer edge of a hole into which a rod, which is a preform of a stress applying part, is inserted. On the other hand, as illustrated in FIG. 5A, in each of the preforms in accordance with Examples 1 to 3, a half line extending from a center of the preform in parallel to a direction in which the stress applying parts are aligned is represented as “L”, and an absolute value of the barrier thickness is a distance from an intersection P of the half line L and a circle overlapping an outer edge of the inner cladding to an intersection Q of the half line L and a circle constituting an outer edge of a hole into which a rod, which is a preform of a stress applying part, is inserted.

A polarization maintaining fiber is manufactured from each of the above preforms in accordance with the above-described manufacturing method. Then, the core diameter (an average value of a core long-axis diameter and a core short-axis diameter), the inner cladding diameter, the outer cladding diameter, the distance between the stress applying parts, the stress applying part diameter, and the barrier thickness of each resultant polarization maintaining fiber were measured. Table 1 below shows results of this measurement. Note that in Table 1 below, the barrier thickness of the polarization maintaining fiber in accordance with each of Examples 1 to 3 is a value predicted on the basis of the barrier thickness of the preform. Further, in Table 1 below, a core non-circularity is a value obtained by measuring the core long-axis diameter and the core short-axis diameter and carrying out a calculation in accordance with the following: core non-circularity={(core long-axis diameter−core short-axis diameter)/(average value of core long-axis diameter and core short-axis diameter)}×100. Note that specifications of polarization maintaining fibers in accordance with Comparative Examples 1 to 3 are defined in FIG. 4B. Meanwhile, specifications of the polarization maintaining fibers in accordance with Examples 1 to 3 are defined in FIG. 5B. Note that as illustrated in FIG. 4B, in each of the polarization maintaining fibers in accordance with Comparative Examples 1 to 3, a half line extending from a center of the polarization maintaining fiber in parallel to a direction in which the stress applying parts are aligned is represented as “L′”, and an absolute value of the barrier thickness is a distance from an intersection P′ of the half line L′ and a circle constituting an outer edge of the inner cladding to an intersection Q′ of the half line L′ and a circle constituting an outer edge of the stress applying part. On the other hand, as illustrated in FIG. 5B, in each of the polarization maintaining fibers in accordance with Examples 1 to 3, a half line extending from a center of the polarization maintaining fiber in parallel to a direction in which the stress applying parts are aligned is represented as “L′”, and an absolute value of the barrier thickness is a distance from an intersection P′ of the half line L′ and a circle constituting an outer edge of the inner cladding to an intersection Q′ of the half line L′ and a circle overlapping an outer edge of the stress applying part.

TABLE 1

| | | | | | | Comparative | Comparative | Comparative |
|---|---|---|---|---|---|---|---|---|
| | Item | Unit | Example 1 | Example 2 | Example 3 | Example 1 | Example 2 | Example 3 |
| Preform | Core | mm | 1.8 | 1.8 | 1.3 | 1.8 | 1.8 | 1.8 |
| | Diameter | | | | | | | |
| | Inner | mm | 6.0 | 7.5 | 4.4 | 6.0 | 6.0 | 6.0 |
| | cladding | | | | | | | |
| | Diameter | | | | | | | |
| | Outer | mm | 39.9 | 39.9 | 45.0 | 39.9 | 40.0 | 40.0 |
| | Cladding | | | | | | | |
| | Diameter | | | | | | | |
| | Distance | mm | 4.0 | 4.0 | 3.6 | 6.0 | 7.0 | 9.0 |
| | Between | | | | | | | |
| | Stress | | | | | | | |
| | applying | | | | | | | |
| | parts | | | | | | | |
| | Barrier | mm | −1.0 | −1.8 | −0.4 | 0.0 | 0.5 | 1.5 |
| | Thickness | | | | | | | |
| | Hole | mm | 11.2 | 11.2 | 12.5 | 11.2 | 11.2 | 11.2 |
| | Diameter | | | | | | | |
| | Stress | mm | 10.5 | 10.5 | 11.8 | 10.5 | 10.5 | 10.5 |
| | applying | | | | | | | |
| | part | | | | | | | |
| | Diameter | | | | | | | |
| | Peripheral | mm | 6.8 | 6.8 | 8.2 | 5.8 | 5.3 | 4.3 |
| | Portion | | | | | | | |
| | Thickness | | | | | | | |
| Fiber | Core | μm | 3.6 | 3.6 | 3.6 | 3.6 | 3.6 | 3.6 |
| | Diameter | | | | | | | |
| | Inner | μm | 12.0 | 15.0 | 12.2 | 12.0 | 12.0 | 12.0 |
| | cladding | | | | | | | |
| | Diameter | | | | | | | |
| | Outer | μm | 80.0 | 80.0 | 125.0 | 80.0 | 79.8 | 80.1 |
| | Cladding | | | | | | | |
| | Diameter | | | | | | | |
| | Distance | μm | 12.0 | 15.0 | 12.2 | 12.0 | 14.0 | 18.0 |
| | Between | | | | | | | |
| | Stress | | | | | | | |
| | applying | | | | | | | |
| | parts | | | | | | | |
| | Barrier | μm | −2.0 | −3.5 | −1.1 | 0.0 | 1.0 | 3.0 |
| | Thickness | | | | | | | |
| | Stress | μm | 22.5 | 22.5 | 34.7 | 22.5 | 22.3 | 22.4 |
| | applying | | | | | | | |
| | part | | | | | | | |
| | Diameter | | | | | | | |
| | Non- | % | 51 | 80 | 21 | 18 | 7 | 4 |
| | Circularity | | | | | | | |

In Examples 1 to 3, it was possible to have a core non-circularity of not less than 20%. Further, in Examples 1 and 2, it was possible to have a core non-circularity of not less than 50%. Furthermore, in Example 2, it was possible to have a core non-circularity of not less than 80%. In other words, it was confirmed that as the absolute value of the barrier thickness in the preform increases, that is, each of the stress applying part causes the inner cladding to be more depressed inward upon each of the stress applying parts, the core non-circularity increases.

Further, Examples 1 to 3 and Comparative Examples 1 to 3 are subjected to mode field pattern measurement. Specifically, measurement of a mode field diameter by a one-dimensional far field pattern method was repeated while the polarization maintaining fiber is rotated by 30°, so that rotational-direction dependency of the mode field diameter was obtained. Measurement results thus obtained were 4.0±0.9 μm in Example 1, 4.0±1.3 μm in Example 2, and 4.0±0.4 μm in Example 3. These measurement results indicate that an elliptical electric field distribution is formed in each of Examples 1 to 3. In contrast, a variation (α of 4.0±α μm) of the mode field diameter was not more than 0.3 μm in Comparative Examples 1 to 3. These measurement results indicate that a substantially circular electric field distribution is formed in each of Comparative Examples 1 to 3.

Note that in each of the preforms of Examples 1 to 3 and Comparative Examples 1 to 3, a dopant added to a core was only germanium. Moreover, a concentration of the germanium in the core was 22 wt %. Further, in each of these preforms, dopants added to the inner cladding were phosphorus, germanium, and fluorine. A concentration of the phosphorus in the inner cladding was 0.8 wt %, and a concentration of the germanium in the inner cladding was 2.9 wt %. A concentration of the fluorine in the inner cladding was adjusted so that the relative refractive index difference of the inner cladding and an outer cladding will be 0.0%. Furthermore, in each of these preforms, a dopant added to the stress applying parts was boron oxide (B₂O₃). A concentration of the boron oxide (B₂O₃) in the stress applying parts was approximately 20 mol %. The polarization maintaining fiber 1 illustrated in FIG. 3 was obtained by drawing the preform of Example 1 in which the above-described dopants were added.

Note that as illustrated in FIG. 4A and FIG. 5A, in the preform of the polarization maintaining fiber, there is a gap between a side surface of the rod which is the preform of the stress applying part and an inner wall of the hole into which the rod is inserted. This gap is eliminated, when the rod melts and becomes low-viscosity glass in drawing and this low-viscosity glass spreads so as to fill the hole. Therefore, a position and a size of the stress applying part in the cross section of the polarization maintaining fiber which has been completed can be predicted on the basis of a position and a size of the hole in the cross section of the preform of the polarization maintaining fiber.

### Application Example

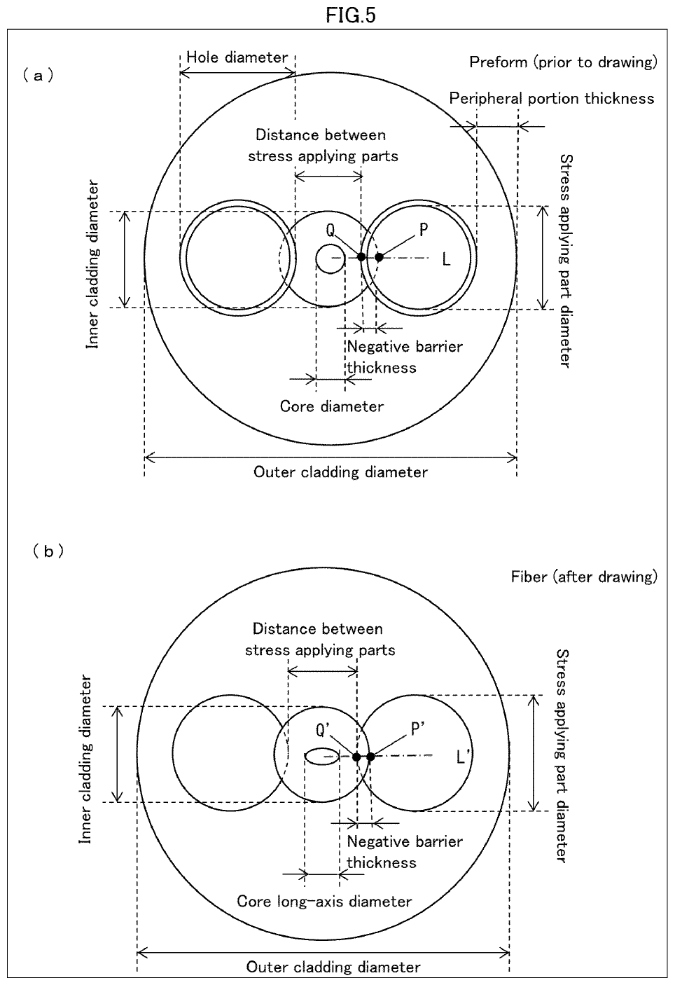

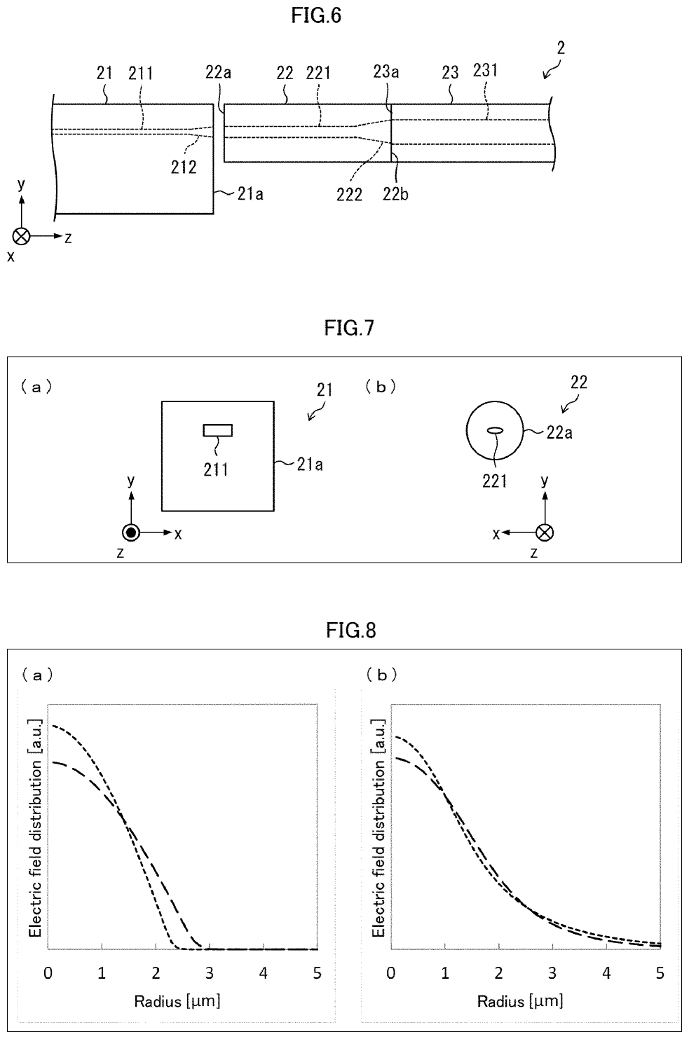

The polarization maintaining fiber 1 can be suitably used in an optical device including a substrate-type optical waveguide and an optical fiber. The following will discuss such an optical device 2, with reference to FIGS. 6 to 8.

FIG. 6 is a side view of the optical device 2. The optical device 2 includes a substrate-type optical waveguide 21, a first optical fiber 22 and a second optical fiber 23, as illustrated in FIG. 6. The substrate-type optical waveguide 21 is optically connected to the first optical fiber 22 by causing an end surface of the substrate-type optical waveguide 21 to be opposed to one end surface of the first optical fiber 22. The second optical fiber 23 is fusion-spliced to the other end surface of the first optical fiber 22. This physically and optically connects the second optical fiber 23 and the first optical fiber 22 to each other. Note that between the end surface of the substrate-type optical waveguide 21 and the one end surface of the polarization maintaining fiber 1 which end surfaces are opposed to each other, a spatial optical system can be provided.

The substrate-type optical waveguide 21 is, for example, a silicon waveguide having a core 211 made of silicon. The substrate-type optical waveguide 21 has a core diameter which is smaller than that of the first optical fiber 22 (described later). Accordingly, the optical device 2 includes a mode field diameter converting section 212 in the vicinity of one of both end surfaces of the core 211 of the substrate-type optical waveguide 21, which one end surface is opposed to a core 221 of the first optical fiber 22. The mode field diameter converting section 212 is provided so as to cause a mode field diameter of the substrate-type optical waveguide 21 to match a mode field diameter of the first optical fiber 22.

FIG. 7A is an elevational view illustrating an end surface 21a of both end surfaces of the substrate-type optical waveguide 21, which end surface 21a is opposed to the first optical fiber 22. The core 211 of the substrate-type optical waveguide 21 has a cross section (end surface) which has a rectangular shape whose long-axis corresponds to an x axis direction, as illustrated in FIG. 7A. Accordingly, the substrate-type optical waveguide 21 has a mode field pattern having an elliptical shape whose long-axis corresponds to the x axis direction.

The first optical fiber 22 is, for example, a glass fiber having a core 221 made of glass, and has a polarization maintaining function which is provided by stress applying parts (not illustrated). The first optical fiber 22 has a core diameter which is smaller than that of the second optical fiber 23 (described later). Accordingly, the optical device 2 includes a mode field diameter converting section 222 in the vicinity of one of both end surfaces of the core 221 of the first optical fiber 22, which one end surface is opposed to a core 231 of the second optical fiber 23. The mode field diameter converting section 222 is provided so as to cause the mode field diameter of the first optical fiber 22 to match a mode field diameter of the second optical fiber 23.

FIG. 7B is an elevational view illustrating an end surface 22a of both end surfaces of the first optical fiber 22, which end surface 22a is opposed to the substrate-type optical waveguide 21. The core 221 of the first optical fiber 22 has a cross section (end surface) which has an elliptical shape whose long-axis corresponds to the x axis direction, as illustrated in FIG. 7B. Accordingly, the first optical fiber 22 has a mode field pattern having an elliptical shape whose long-axis corresponds to the x axis direction, like the mode field pattern of the substrate-type optical waveguide 21. This makes it possible to reduce a coupling loss between the substrate-type optical waveguide 21 and the first optical fiber 22 to a low level.

The second optical fiber 23 is, for example, a glass fiber having a core 231 made of glass, and has a polarization maintaining function which is provided by stress applying parts (not illustrated). The core 231 of the second optical fiber 23 has a cross section (end surface) which has a circular shape.

The polarization maintaining fiber 1 described above can be suitably used as the first optical fiber 22 in the optical device 2.

Note that the inner cladding 12 of the polarization maintaining fiber 1 is doped with fluorine as described above. This fluorine has a diffusion promoting effect which promotes diffusion, by heating, of germanium added to the core 11. Accordingly, in a case where the polarization maintaining fiber 1 is used as the first optical fiber 22, it is possible to expand the core diameter of the first optical fiber 22 in the vicinity of a fusion-splicing point by heat for fusion-splicing the first optical fiber 22 to the second optical fiber 23. Accordingly, in a case where the polarization maintaining fiber 1 is used as the first optical fiber 22, it is possible to easily provide the mode field diameter converting section 222 only by fusion-splicing the first optical fiber 22 to the second optical fiber 23.

FIG. 8A is a graph showing a mode field pattern of the substrate-type optical waveguide 21. In FIG. 8A, a chained line represents an electric field distribution along a straight line which passes through a central axis of the core 211 and which is parallel to the x axis, and a dotted line represents an electric field distribution along a straight line which passes through the central axis of the core 211 and which is parallel to a y axis. FIG. 8B is a graph showing a mode field pattern of the first optical fiber 22 (polarization maintaining fiber 1). In FIG. 8B, a chained line represents an electric field distribution along a straight line which passes through a central axis of the core 221 and which is parallel to the x axis, and a dotted line represents an electric field distribution along a straight line which passes through the central axis of the core 221 and which is parallel to the y axis. In comparison of the above graphs, it can be found that the mode field pattern of the substrate-type optical waveguide 21 well matches the mode field pattern of the first optical fiber 22.

Note that though the above-described Application Example employs the polarization maintaining fiber 1 as the first optical fiber 22 in the optical device 2 including the substrate-type optical waveguide 21, the first optical fiber 22, and the second optical fiber 23, the present invention is not limited to this Application Example. For example, the polarization maintaining fiber 1 can be used as the first optical fiber 22 in an optical device 2 in which the substrate-type optical waveguide 21 is omitted, that is, in an optical device 2 including the first optical fiber 22 and the second optical fiber 23. Alternatively, the polarization maintaining fiber 1 can be used as the first optical fiber 22 in an optical device 2 in which the second optical fiber 23 is omitted, that is, in an optical device 2 including the substrate-type optical waveguide 21 and the first optical fiber 22.

(Supplemental Notes Regarding Melt Viscosity)

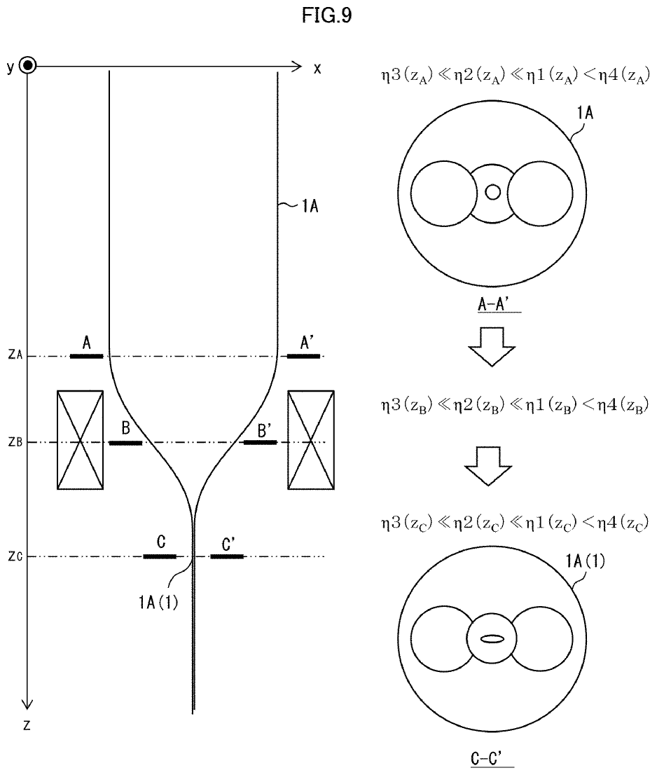

As described above, the melt viscosity η1 of the core 11, the melt viscosity η2 of the inner cladding 12, the melt viscosity η3 of the stress applying parts 13a and 13b, and the melt viscosity η4 of the outer cladding 14 have the following relation: η3<<η2<<ηl<η4. Note that the inequality sign “<<” between η3 and η2 means that a difference between η3 and η2 is larger than a difference between η1 and η4, but does not mean the difference between η3 and η2 is larger than a specific value. Similarly, the inequality sign “<<” between η2 and η1 means that a difference between η2 and η1 is larger than the difference between η1 and η4, but does not mean that the difference between η2 and η1 is larger than a specific value. The following supplements the description of the melt viscosity η1 of the core 11, the melt viscosity η2 of the inner cladding 12, the melt viscosity η3 of the stress applying parts 13a and 13b, and the melt viscosity η4 of the outer cladding 14, with reference to FIG. 9.

FIG. 9 includes a side view illustrating the preform 1A during drawing of the polarization maintaining fiber 1, a cross sectional view illustrating a cross section (i.e., an XY plane) taken along line A-A′ (hereinafter, referred to as A-A′ cross section), and a cross sectional view illustrating a cross section (i.e., another XY plane) taken along line C-C′ (hereinafter, referred to as C-C′ cross section). For easy understanding of this drawing, a size of the cross sectional view of the A-A′ cross section is the same as a size of the cross sectional view of the C-C′ cross section in FIG. 9. However, in practice, the sizes of the A-A′ cross section and the C-C′ cross section are different from each other. A diameter of the preform 1A is decreased in a drawing furnace, as illustrated in FIG. 9. The A-A′ cross section illustrated in FIG. 9 is a cross section where the diameter of the preform 1A starts decreasing, that is, a cross section where melting starts. Accordingly, the diameter of the preform 1A above the A-A′ cross section corresponds to a diameter of the preform 1A prior to drawing, and the diameter of the preform 1A below the A-A′ cross section is smaller than the diameter of the preform 1A prior to drawing. Further, the C-C′ cross section illustrated in FIG. 9 is a cross section where the diameter of the preform 1A stops decreasing, that is, a cross section where melting ends or a cross section at the time when solidification finishes and the polarization maintaining fiber 1 is completed. Accordingly, the diameter of the preform 1A above the C-C′ cross section is larger than a diameter of the preform 1A after drawing, and the diameter of the preform 1A below the C-C′ cross section corresponds to a diameter of the preform 1A after drawing. Further, the line B-B′ illustrated in FIG. 9 is an imaginary line indicating, in the form of a line extending along an X axis direction of FIG. 9, a region where the preform 1A is at the highest temperature. The B-B′ line is present between the A-A′ cross section and the C-C′ cross section. Note that a zone from the A-A′ cross section to the C-C′ cross section of the preform 1A may also be referred to as “neckdown”. The A-A′ cross section can be rephrased as a cross section at which neckdown starts. Meanwhile, the C-C′ cross section can be rephrased as a cross section at which neckdown ends. Further, the preform 1A after drawing can be rephrased as the polarization maintaining fiber 1.

In the preform 1A from the start of melting to the end of melting, that is, in the preform 1A from the A-A′ cross section to the C-C′ cross section, each of respective values of the melt viscosities η1, η2, η3, and η4 may differ depending on a position along a Z axis direction and on a position along the X axis direction. This is because the melt viscosities η1, η2, η3, and η4 each depend on a temperature of the preform 1A, and the temperature of the preform 1A may vary depending on a position. In light of the above, the melt viscosity η1 at a position (x, y, z) is represented as η1(x, y, z), the melt viscosity η2 at a position (x, y, z) is represented as η2(x, y, z), the melt viscosity η3 at a position (x, y, z) is represented as η3(x, y, z), and the melt viscosity η4 at a position (x, y, z) is represented as η4(x, y, z). Here, a z axis is a coordinate axis parallel to a long-axis of the preform 1A, and an x axis and a y axis are coordinate axes orthogonal to the long-axis of the preform 1A.

Then, at each cross section from the A-A′ cross section to the C-C′ cross section, η1 (z) is defined as a spatial average of melt viscosity η1(x, y, z) at that cross section, η2(z) is defined as a spatial average of melt viscosity η2(x, y, z) at that cross section, η3(z) is defined as a spatial average of melt viscosity η3(x, y, z) at that cross section, and η4(z) is defined as a spatial average of melt viscosity η4(x, y, z) at that cross section. For example, melt viscosities η1(z_{A}), η2(z_{A}), η3(z_{A}), and η4(z_{A}) at the A-A′ cross section are defined as respective spatial averages of melt viscosities η1 (x, y, z_{A}), η2 (x, y, z_{A}), η3(x, y, z_{A}), and η4(x, y, z_{A}) at the A-A′ cross section. Further, melt viscosities η1 (z_{B}), η2(z_{B}), η3 (z_{B}), and η4 (z_{B}) at a cross section taken along line B-B′ (hereinafter, referred to as B-B′ cross section) are defined as respective spatial averages of melt viscosities η1 (x, y, z_{B}), η2 (x, y, z_{B}), η3 (x, y, z_{B}), and η4 (x, y, z_{B}) at the B-B′ cross section. In addition, melt viscosities η1(z_{C}), η2 (z_{C}), η3 (z_{C}), and η4 (z_{C}) at the C-C′ cross section are defined as respective spatial averages of melt viscosities η1 (x, y, z_{C}), η2 (x, y, z_{C}), η3 (x, y, z_{C}), and η4 (x, y, z_{C}) at the C-C′ cross section.

Respective values of melt viscosities η1(z), η2(z), η3(z), and η4(z) at each cross section from the A-A′ cross section to the C-C′ cross section may differ depending on each cross section which is an XY plane. However, an essential point in flattening of the core 11 is not the values of the melt viscosities η1(z), η2(z), η3(z), and η4(z) at each cross section from the A-A′ cross section to the C-C′ cross section but a magnitude relation of the melt viscosities η1(z), η2(z), η3(z), and η4(z) at each cross section from the A-A′ cross section to the C-C′ cross section.

Note that though in the above-described embodiments, the preform 1A satisfying the following Condition 1 has been described, the present invention is not limited to such a preform 1A. In other words, a preform 1A satisfying the following Condition 2 or 3 also allows for flattening of the core 11 as with the preform 1A which satisfies the following Condition 1.

Condition 1: At any cross section from the A-A′ cross section to the C-C′ cross section, the melt viscosities η1(z), η2(z), η3(z), and η4(z) have the following magnitude relation: η3(z)<<η2(z)<<η1(z)<η4(z). Further, at least in a cooling process, the melt viscosities η1(z), η2(z), η3(z), and η4(z) have the following magnitude relation: η3(z)<<η2(z)<<η1(z)<η4(z). Furthermore, at least in the cooling process, the melt viscosities η1(z), η2(z), η3(z), and η4(z) have the following magnitude relation: η3(z)<η2 (z)<η1(z)<η4(z).

Condition 2: Among the melt viscosities η1(z), η2(z), η3(z) and η4(z) at least in the cooling process, the following magnitude relation is established: η3(z)<η1(z)<η2(z)<η4(z).

Condition 3: Among the melt viscosities η1(z), η2(z), η3(z) and η4(z) at least in the cooling process, the following magnitude relation is established: η3(z)<η2(z)=η1(z)<η4(z).

The above Conditions 1 to 3 can be summarized as below. That is, among the melt viscosities η1(z), η2(z), η3(z) and η4(z) at least in the cooling process, the following magnitude relations are established: η3(z)<η2(z)<η4(z), and η3(z)<η1(z)<η4(z). Here, though it is not necessary that the magnitude relations η3(z)<η2(z)<η4(z) and η3(z)<η1(z)<η4(z) are always established among the melt viscosities η1(z), η2(z), η3(z) and η4(z) before and after the cooling process, these magnitude relations can be established before and after the cooling process.

Here, under each condition of the above Conditions 1 to 3, respective dopant concentrations of the core 11, the inner cladding 12, the stress applying parts 13a and 13b, and the outer cladding 14 should be set so that the relations η3(z)<η2(z)<η4(z) and η3(z)<η1(z)<η4(z) will be satisfied. For example, in a case where (i) the core 11 is doped with germanium, (ii) the inner cladding 12 is doped with phosphorus, germanium, and fluorine, (iii) the two stress applying parts 13a and 13b are doped with boron oxide (B₂O₃), and (iv) the outer cladding 14 is made of quartz glass which is not intentionally doped with any dopant except for chlorine (Cl), the respective dopant concentrations as below should be set so that the relations η3(z)<η2(z)<η4 (z) and η3(z)<η1(z)<η4 (z) will be satisfied. In other words, (i) the concentration of the germanium in the core 11 is set, for example, in a range of 10 wt % to 30 wt %; (ii) the concentration of the phosphorus in the inner cladding 12 is set, for example, in a range of 0.5 wt % to 2.0 wt %, the concentration of the germanium in the inner cladding 12 is set, for example, in a range of 1.5 wt % to 5.0 wt %, and the concentration of the boron oxide in the inner cladding 12 is set so that the relative refractive index difference of the refractive index n2 of the inner cladding 12 to the refractive index n4 of the outer cladding 14 will be not more than 0.1%; (iii) the concentration of the boron oxide in the two stress applying parts 13a and 13b is set, for example, in a range of 15 mol % to 25 mol %; and (iv) the concentration of the chlorine in the outer cladding 14 is set so that the relative refractive index difference of the refractive index n2 of the inner cladding 12 to the refractive index n4 of the outer cladding 14 will be not more than 0.1%, and further, (v) these concentrations should be set so that the relations η3(z)<η2(z)<η4(z) and η3(z)<η1(z)<η4(z) will be satisfied.

Further, under each of the above-described Conditions 1 to 3, the temperature of the preform 1A should be set so that the following (CONDITION 1) and (CONDITION 2) are satisfied.

(CONDITION 1) Respective temperatures of the core 11, the inner cladding 12, the stress applying parts 13a and 13b, and the outer cladding 14 at least immediately before the cooling process are each not less than a melting temperature of each of the core 11, the inner cladding 12, the stress applying parts 13a and 13b, and the outer cladding 14. (CONDITION 2) Among the melt viscosities η1(z), η2(z), η3(z) and η4(z) at least in the cooling process, the following magnitude relations are established: η3(z)<η2(z)<η4(z), and η3(z)<η1(z)<η4(z).

Here, “the melt viscosities η1(z), η2(z), η3(z) and η4(z) in the cooling process” means melt viscosities η1(z), η2(z), η3(z) and η4(z) at any cross section between the B-B′ cross section where the temperature is the highest and the C-C′ cross section where the diameter of the cross section stops decreasing. Accordingly, the preform 1A which has been melted is cooled mainly between the B-B′ cross section and the C-C′ cross section.

Meanwhile, though in the present specification, η1(z), η2(z), η3(z), and η4(z) at each cross section from the A-A′ cross section to the C-C′ cross section are defined as respective spatial averages of melt viscosities η1 (x, y, z), η2(x, y, z), η3(x, y, z), and η4(x, y, z) at that cross section, the present invention is not limited to such a configuration. In other words, it is possible to define η1(z), η2(z), η3(z), and η4(z) at each cross section from the A-A′ cross section to the C-C′ cross section as any of the following (a) to (c): (a) respective minimum values of melt viscosities η1(x, y, z), η2(x, y, z), η3(x, y, z), and η4(x, y, z) at that cross section; (b) respective maximum values of melt viscosities η1(x, y, z), η2(x, y, z), η3(x, y, z), and η4(x, y, z) at that cross section; and (c) respective central values of melt viscosities η1 (x, y, z), η2(x, y, z), η3 (x, y, z), and η4 (x, y, z) at that cross section. Even in a case where any of the above definitions is employed, the core 11 can be flattened as long as the preform 1A satisfies the above Condition 1. Further, the core 11 can be flattened if the preform 1A satisfies the above Condition 2.

Note that when the preform 1A satisfying the above Condition 2 is melted, the magnitude relations η3(z)<η2(z)<η4(z) and η3(z)<η1(z)<η4(z) are established at any cross section. Further, with regard to the polarization maintaining fiber 1 manufactured from the preform 1A satisfying the above Condition 2, when the polarization maintaining fiber 1 is melted, the magnitude relations η3(z)<η2(z)<η4(z) and η3(z)<η1(z)<η4(z) are established at any cross section. In other words, the preform 1A for use in the above-described manufacturing method can be characterized in that the magnitude relations η3(z)<η2(z)<η4(z) and η3(z)<η1(z)<η4(z) are established at any cross section when the preform 1A is melted. Similarly, the polarization maintaining fiber 1 manufactured by the above-described manufacturing method can be characterized in that the magnitude relations η3(z)<η2(z)<η4(z) and η3(z)<η1(z)<η4(z) are established at any cross section when the polarization maintaining fiber 1 is melted.

### Supplemental Notes Regarding Advantageous Effects

The polarization maintaining fiber 1 includes the core 11 doped with germanium and the inner cladding 12 codoped with dopants such as fluorine and phosphorus. This polarization maintaining fiber 1 can advantageously reduce a coupling loss to a low level in a case where the polarization maintaining fiber 1 is fusion-spliced to another optical fiber which has a larger mode field diameter than the polarization maintaining fiber 1 and which includes a core whose cross section is circular. The polarization maintaining fiber 1 has such an advantageous effect for at least two reasons.

The first reason is that as widely known as a thermally diffused expanded core (TEC) technique, germanium added to the core 11 diffuses into the inner cladding 12 due to heating in fusion-splicing and consequently, the mode field diameter of the polarization maintaining fiber 1 increases. The second reason is that as disclosed in Reference Literature below, flatness of the cross section of the core of the polarization maintaining fiber 1 becomes lower (e.g., the core having an elliptical shape approaches a true circle shape) when the germanium added to the core 11 diffuses into the inner cladding 12 due to heating in fusion-splicing.

Reference Literature: H. YOKOTA, et al., “Design of Polarization-Maintaning Optical Fiber Suitable for Thermally-Diffused Expanded Core Techniques,” IEICE TRANS. COMMUN., VOL. E80-B, NO. 4, pp 516-521, APRIL 1997.

Note that the polarization maintaining fiber 1 including the core 11 doped with germanium and the inner cladding 12 codoped with dopants can advantageously reduce a coupling loss to a low level in a case where the polarization maintaining fiber 1 is connected to a substrate-type optical waveguide having an elliptical mode field pattern. This is because the polarization maintaining fiber 1 and the substrate-type optical waveguide can be connected to each other, while the polarization maintaining fiber 1 is not subjected to heating and the cross section of the core is kept flattened. It can be accordingly said that the polarization maintaining fiber 1 including the core 11 doped with germanium and the inner cladding 12 codoped with dopants is an excellent polarization maintaining fiber having the following advantages (a) and (b): (a) in a case where the polarization maintaining fiber 1 is fusion-spliced to another optical fiber which has a larger mode field diameter than the polarization maintaining fiber 1 and which includes a core whose cross section is circular, a coupling loss can be reduced to a low level since the mode field diameter of the polarization maintaining fiber 1 easily approaches the mode field diameter of the another optical fiber; and (b) a coupling loss can be reduced to a low level in a case where the polarization maintaining fiber 1 is connected to a substrate-type optical waveguide having an elliptical mode field pattern. Further, it can be also said that the optical device 2 (see FIGS. 6 to 8) including the polarization maintaining fiber 1 is an excellent optical device having similar advantages.

[Recap]

A polarization maintaining fiber in accordance with one or more embodiments of the present invention is configured to include: a core; an inner cladding enclosing the core; two stress applying parts provided on both sides of the inner cladding and sandwiching the inner cladding therebetween; and an outer cladding enclosing the inner cladding and the two stress applying parts, the inner cladding causing each of the two stress applying parts to be depressed inward upon the inner cladding such that the inner cladding is received in a depression of each of the two stress applying parts, and the core having a cross section flattened such that a long-axis of the core corresponds to a direction in which the two stress applying parts are aligned.

The polarization maintaining fiber configured as above includes a core, an inner cladding enclosing the core, two stress applying parts provided on both sides of the inner cladding and sandwiching the inner cladding therebetween, and an outer cladding enclosing the inner cladding and the two stress applying parts, and can be easily manufactured by drawing a preform in which each of the two stress applying parts causes the inner cladding to be depressed inward upon each of the two stress applying parts such that each of the two stress applying parts is received in a depression of the inner cladding. The above configuration accordingly makes it possible to provide a polarization maintaining fiber including a core whose cross section is flattened, which polarization maintaining fiber can be easily manufactured. Note that the preform described above can be provided, for example, by first, forming holes so as to cause the inner cladding to be depressed inward, by using a drilling tool or the like, and then, inserting, into each of the holes, a rod which is a preform of each of the stress applying parts.

The polarization maintaining fiber in accordance with one or more embodiments of the present invention is configured such that: the two stress applying parts are each made of quartz glass doped with boron.

The above configuration makes it possible to make the melt viscosity of the stress applying parts significantly lower than the melt viscosity of pure quartz glass. This allows solidification of the stress applying parts to occur later than solidification of the core and the inner cladding, after drawing. Accordingly, it is possible to simultaneously (i) deform the inner cladding so as to cause each of the stress applying parts to be depressed inward upon the inner cladding such that the inner cladding is received in a depression of each of the stress applying parts and (ii) deform the core so as to cause the cross section of the core to be flattened.

The polarization maintaining fiber in accordance with one or more embodiments of the present invention is configured such that: the core is made of quartz glass doped with germanium; and the inner cladding is made of quartz glass doped with fluorine and an updopant which cancels a refractive index decreasing effect of the fluorine.

The above configuration makes it possible to diffuse, by heating, the germanium added to the core into the inner cladding, since the fluorine is added to the inner cladding. In other words, the above configuration makes it possible to provide a polarization maintaining fiber having a property that its core is expanded by heating. Note that since the inner cladding is doped with the updopant which cancels the refractive index decreasing effect of the fluorine, there is no possibility that a difference in refractive index between the core and the inner cladding is lost. Accordingly, the above configuration makes it possible to provide a polarization maintaining fiber which has a property that its core is expanded by heating while a light confining function is not impaired.

The polarization maintaining fiber in accordance with one or more embodiments of the present invention is configured such that the updopant contains one or both of phosphorus and germanium.

The above configuration makes it possible to cancel the refractive index decreasing effect of the fluorine by a refractive index increasing effect(s) of one or both of the phosphorus and the germanium.

The polarization maintaining fiber in accordance with one or more embodiments of the present invention is configured such that: a melt viscosity η1(z) of the core, a melt viscosity η2(z) of the inner cladding, a melt viscosity η3(z) of the stress applying parts, and a melt viscosity η4(z) of the outer cladding, at each cross section, have the following magnitude relations: η3(z)<η2(z)<η4(z), and η3(z)<η1(z)<η4(z).

The above configuration can provide a polarization maintaining fiber including a core whose cross section is flattened, which polarization maintaining fiber can be more easily manufactured.

An optical device in accordance with one or more embodiments of the present invention is configured to include: a polarization maintaining fiber in accordance with one or more embodiments of the present invention; and an optical waveguide having an end surface opposed to an end surface of the polarization maintaining fiber, the optical waveguide having an elliptical mode field pattern.

The above configuration allows the mode field pattern of the polarization maintaining fiber to be elliptical like the mode field pattern of the optical waveguide. Therefore, it is possible to provide an optical device whose coupling loss is low.

An optical device in accordance with one or more embodiments of the present invention is configured to include: a polarization maintaining fiber in accordance with one or more embodiments of the present invention; and an optical fiber having an end surface fusion-spliced to an end surface of the polarization maintaining fiber, the optical fiber having a larger mode field diameter than the polarization maintaining fiber.

With the configuration, in a case where (i) the core of the polarization maintaining fiber is made of quartz glass doped with germanium and (ii) the inner cladding of the polarization maintaining fiber is made of quartz glass doped with fluorine and an updopant which cancels a refractive index decreasing effect of the fluorine, a mode field converting section for causing the mode field diameter of the polarization maintaining fiber to match the mode field diameter of the optical fiber can be easily formed when the polarization maintaining fiber is fusion-spliced to the optical fiber.

An optical device in accordance with one or more embodiments of the present invention is configured to include: a polarization maintaining fiber in accordance with one or more embodiments of the present invention; an optical waveguide having an end surface opposed to one end surface of the polarization maintaining fiber, the optical waveguide having an elliptical mode field pattern; and an optical fiber having an end surface fusion-spliced to another end surface of the polarization maintaining fiber, the optical fiber having a larger mode field diameter than the polarization maintaining fiber.

The above configuration allows the mode field pattern of the polarization maintaining fiber to be elliptical like the mode field pattern of the optical waveguide. This makes it possible to reduce a coupling loss between the polarization maintaining fiber and the optical waveguide to a low level. Further, with the above configuration, in a case where (i) the core of the polarization maintaining fiber is made of quartz glass doped with germanium and (ii) the inner cladding of the polarization maintaining fiber is made of quartz glass doped with fluorine and an updopant which cancels a refractive index decreasing effect of the fluorine, a mode field converting section for causing the mode field diameter of the polarization maintaining fiber to match the mode field diameter of the optical fiber can be easily formed when the polarization maintaining fiber is fusion-spliced to the optical fiber. This makes it possible to reduce a coupling loss between the polarization maintaining fiber and the optical fiber to a low level.

A polarization maintaining fiber preform in accordance with one or more embodiments of the present invention is configured to include: a core; an inner cladding enclosing the core; two stress applying parts provided on both sides of the inner cladding and sandwiching the inner cladding therebetween; and an outer cladding enclosing the inner cladding and the two stress applying parts, each of the two stress applying parts causing the inner cladding to be depressed inward upon each of the two stress applying parts such that each of the two stress applying parts is received in a depression of the inner cladding.

The above configuration can provide a polarization maintaining fiber preform which makes it possible to easily obtain, by drawing the polarization maintaining fiber preform, a polarization maintaining fiber whose cross section is flattened.

The polarization maintaining fiber preform in accordance with one or more embodiments of the present invention is configured such that: a melt viscosity η1(z) of the core, a melt viscosity η2(z) of the inner cladding, a melt viscosity η3(z) of the stress applying parts, and a melt viscosity η4(z) of the outer cladding, at each cross section, have the following magnitude relations: η3(z)<η2(z)<η4(z), and η3(z)<η1(z)<η4(z).

The above configuration can provide a polarization maintaining fiber preform which makes it possible to more easily obtain, by drawing the polarization maintaining fiber preform, a polarization maintaining fiber whose cross section is flattened.

A method, in accordance with one or more embodiments of the present invention, for manufacturing a polarization maintaining fiber is configured to include the step of: drawing a preform including a core, an inner cladding enclosing the core, stress applying parts provided on both sides of the inner cladding and sandwiching the inner cladding therebetween, and an outer cladding enclosing the inner cladding and the two stress applying parts, in the preform, each of the two stress applying parts causing the inner cladding to be depressed inward upon each of the two stress applying parts such that each of the two stress applying parts is received in a depression of the inner cladding, and in the polarization maintaining fiber, the inner cladding causing each of the two stress applying parts to be depressed inward upon the inner cladding such that the inner cladding is received in a depression of each of the two stress applying parts, and the core having a cross section flattened such that a long-axis of the core corresponds to a direction in which the two stress applying parts are aligned.

The above configuration makes it possible to easily manufacture a polarization maintaining fiber whose cross section is flattened.

The method in accordance with one or more embodiments of the present invention is configured such that: in the preform being subjected to drawing, a melt viscosity η1(z) of the core, a melt viscosity η2(z) of the inner cladding, a melt viscosity η3(z) of the stress applying parts, and a melt viscosity η4(z) of the outer cladding, at a cross section between a cross section at a highest temperature and a cross section where a diameter of the cross section stops decreasing, have the following magnitude relations: η3(z)<η2(z)<η4(z), and η3(z)<η1(z)<η4(z).

The above configuration makes it possible to more easily manufacture a polarization maintaining fiber whose cross section is flattened.

### Additional Remarks

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 polarization maintaining fiber
11 core
12 inner cladding
13a, 13b stress applying part
14 outer cladding
1A preform of polarization maintaining fiber (polarization maintaining fiber preform)
2 optical device
21 substrate-type optical waveguide (optical waveguide)
22 first optical fiber (polarization maintaining fiber)
23 second optical fiber

1. A polarization maintaining fiber comprising:
a core;
an inner cladding enclosing the core;
two stress applying parts that sandwich the inner cladding therebetween; and
an outer cladding enclosing the inner cladding and the two stress applying parts, wherein
each of the two stress applying parts is depressed inward against the inner cladding, and
the core has a flattened cross section having a long-axis that corresponds to a direction in which the two stress applying parts are aligned.

2. The polarization maintaining fiber as set forth in claim 1, wherein:
the two stress applying parts are each made of quartz glass doped with boron.

3. The polarization maintaining fiber as set forth in claim 1, wherein:
a melt viscosity η1(z) of the core, a melt viscosity η2(z) of the inner cladding, a melt viscosity η3(z) of the stress applying parts, and a melt viscosity η4(z) of the outer cladding, at each cross section, have the following magnitude relations:
η3(z)<η2(z)<η4(z), and η3(z)<η1(z)<η4(z).

4. The polarization maintaining fiber as set forth in claim 1, wherein:
the core is made of quartz glass doped with germanium, and
the inner cladding is made of quartz glass doped with fluorine and an updopant that cancels a refractive index decreasing effect of the fluorine.

5. The polarization maintaining fiber as set forth in claim 4, wherein:
the updopant contains one or both of phosphorus and germanium.

6. An optical device comprising:
the polarization maintaining fiber as set forth in claim 1; and
an optical waveguide having an end surface opposed to an end surface of the polarization maintaining fiber, wherein
the optical waveguide has an elliptical mode field pattern.

7. An optical device comprising:
the polarization maintaining fiber as set forth in claim 4; and
an optical fiber having an end surface fusion-spliced to an end surface of the polarization maintaining fiber, wherein
the optical fiber has a larger mode field diameter than the polarization maintaining fiber.

8. An optical device comprising:
the polarization maintaining fiber as set forth in claim 4;
an optical waveguide having an end surface opposed to one end surface of the polarization maintaining fiber, wherein the optical waveguide has an elliptical mode field pattern; and
an optical fiber having an end surface fusion-spliced to another end surface of the polarization maintaining fiber, wherein the optical fiber has a larger mode field diameter than the polarization maintaining fiber.

9. A polarization maintaining fiber preform comprising:
a core;
an inner cladding enclosing the core;
two stress applying parts that sandwich the inner cladding therebetween; and
an outer cladding enclosing the inner cladding and the two stress applying parts, wherein
the inner cladding is depressed inward against each of the two stress applying parts.

10. The polarization maintaining fiber preform as set forth in claim 9, wherein:
a melt viscosity η1(z) of the core, a melt viscosity η2(z) of the inner cladding, a melt viscosity η3(z) of the stress applying parts, and a melt viscosity η4(z) of the outer cladding, at each cross section, have the following magnitude relations:
η3(z)<η2(z)<η4(z), and η3(z)<η1(z)<η4(z).

11. A method for manufacturing a polarization maintaining fiber, comprising:
drawing a preform including a core, an inner cladding enclosing the core, two stress applying parts that sandwich the inner cladding therebetween, and an outer cladding enclosing the inner cladding and the two stress applying parts, wherein
in the preform, the inner cladding is depressed inward against each of the two stress applying parts,
in the polarization maintaining fiber, each of the two stress applying parts is depressed inward against the inner cladding, and
the core has a flattened cross section having a long-axis of the core that corresponds to a direction in which the two stress applying parts are aligned.

12. The method as set forth in claim 11, wherein:
in the preform being subjected to drawing, a melt viscosity η1(z) of the core, a melt viscosity η2(z) of the inner cladding, a melt viscosity η3(z) of the stress applying parts, and a melt viscosity η4(z) of the outer cladding, at a cross section between a cross section at a highest temperature and a cross section where a diameter of the cross section stops decreasing, have the following magnitude relations:
η3(z)<η2(z)<η4(z), and η3(z)<η1(z)<η4(z).
